(19) United States
(12) Patent Application Publication
(10) Pub. No.: US 2016/0335704 A1
(43) Pub. Date: Nov. 17, 2016

(54) Method, Apparatus and System for Content Recommendation

(71) Applicant: NOKIA TECHNOLOGIES OY, Espoo (FI)

(72) Inventors: Alvin Chin, Beijing (CN); Guangxiang Zeng, Hefei, Anhui (CN); Jilei Tian, Beijing (CN); Enhong Chen, Hefei, Anhui (CN)

(21) Appl. No.: 15/112,530

(22) PCT Filed: Jan. 29, 2014
(86) PCT No.: PCT/CN2014/071735

§ 371 Date: Jul. 19, 2016

(51) Int. Cl. G06Q 30/06; G06F 17/30; G06Q 30/02; H04L 29/06

(52) U.S. Cl. CPC G06Q 30/0631; H04L 63/10; G06F 17/3053; G06Q 30/0269; G06Q 30/0277

(57) ABSTRACT

Method, apparatus, system, computer program product and computer readable medium are disclosed for recommending content to a plurality of users. Each of the users is associated with a user score. The method comprises determining a recommending score for an item of content at least partly based on a user's promotion of the item and the user score of the promoting user; recommending the item according to its recommending score; and adjusting the user score of the promoting user based on other users' feedback with respect to the item promoted by said user.

### FIELD OF THE INVENTION

Embodiments of the disclosure generally relate to information technology, and, more particularly, to computer-based recommendation technology.

### BACKGROUND

Recommendation systems and methods that recommend items or people of interest to users have been evolving and are increasingly useful. Existing machine recommendation systems mostly rely on intelligence learned from data and have developed strengths in user behavior modeling, such as collaborative filtering on user-content-rating data. On the other hand, human beings are still the best in judging the quality of content. Human recommendation is in a better position to improve content relevancy and quality since most content is composed of language and semantic rich data, for which machine learning is weaker than human beings. Therefore it is desirable to combine the strengths of both machine and human recommendations to improve the recommendation performance and content quality.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one aspect of the disclosure, it is provided a method for recommending content to a plurality of users. Each of the users is associated with a user score. The method comprises determining a recommending score for an item of content at least partly based on a user's promotion of the item and the user score of the promoting user; recommending the item according to its recommending score; and adjusting the user score of the promoting user based on other users' feedback with respect to the item promoted by said user.

According to another aspect of the present disclosure, it is provided a computer program product embodied on a distribution medium readable by a computer and comprising program instructions which, when loaded into a computer, execute the above-described method.

According to still another aspect of the present disclosure, it is provided a non-transitory computer readable medium having encoded thereon statements and instructions to cause a processor to execute the above-described method.

According to still another aspect of the present disclosure, it is provided a system for recommending content to a plurality of users. Each user is associated with a user score. The system comprising: a content database configured to store a plurality of items of content; a user database configured to store information about the users, wherein each user is associated with a user score; a first recommender configured to determine a recommending score for an item at least partly based on a user's promotion of the item and the user score of the promoting user, and recommend the item according to its recommending score; and a feedback analytics configured to collect feedback from the users and adjust the user score of the promoting user based on other users' feedback with respect to the item promoted by that user.

These and other objects, features and advantages of the disclosure will become apparent from the following detailed description of illustrative embodiments thereof, which is to be read in connection with the accompanying drawings.

### BRIEF DESCRIPTION OF THE DRAWINGS

FIG. 1 is a simplified block diagram illustrating a system according to an embodiment;

FIG. 2 is a flow chart depicting a process of recommendation according to an embodiment;

FIG. 3 is an illustrative diagram showing an example of item promotion, user feedback and user score update according to an embodiment;

FIG. 4 is a diagram showing the update of user scores according to an embodiment;

FIG. 5 shows an illustrative user interface with which a user can view, promote and vote items of content according to an embodiment; and

FIG. 6 is an illustrative diagram showing a process of recommendation according to an embodiment.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

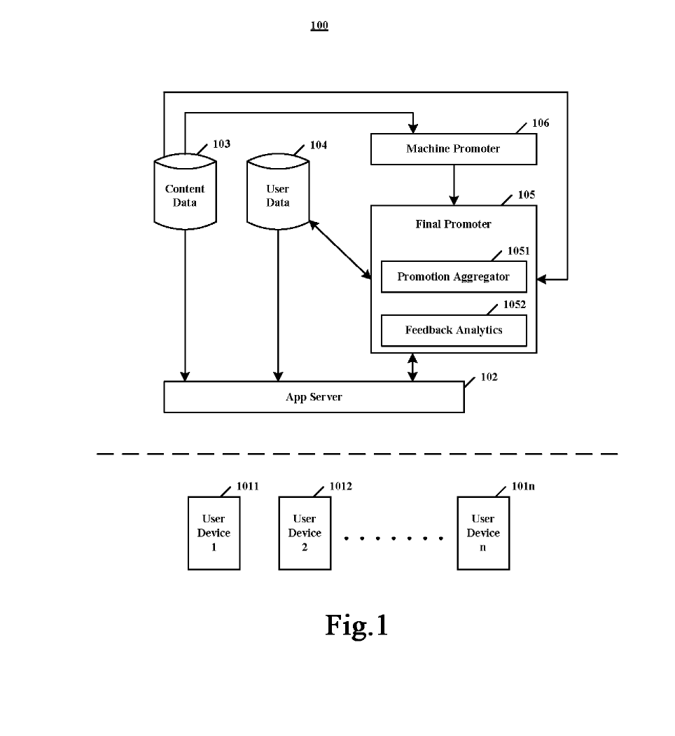

As described herein, an aspect of the disclosure includes providing enhanced content recommendation. FIG. 1 shows a system that is capable of recommending content to users according to an embodiment.

As shown in FIG. 1, the system 100 comprises a plurality of user devices 1011-101n each operably connected to an application server 102. The user devices 1011-101n can be any kind of user equipment or computing device including, but not limited to, smart phones, tablets, laptops and PCs, running with any kind of operating system including, but not limited to, Windows, Android and iOS. The connection between the application server 102 and one of the user devices 1011-101n can be done in any form, such as, internet, intranet, cellular network, local area network (LAN), wide area network (WAN), wireless LAN, or their combination. For example, the user devices 1011-101n can be Windows phones, having an app installed in it, with which the users can access the service provided by the application server 102. The service can be any kind of service including, but not limited to, news service such as Nokia Xpress Now, NBC News, social networking service such as Linkedin, Facebook, Twitter, YouTube and messaging service such as WeChat, Yahoo! Mail, etc. The users can also access the service with web browsers, such as Internet Explorer, Chrome and Firefox, installed in the user devices 1011-101n. In this case, the application server 102 would be a web server.

Content data 103 comprise a plurality of content items that the application server 102 and other components of the system 100 can choose and recommend to the users. An item of content can be a piece of information in any form, such as, text, audio, video, images, ads, multi-media, etc. The content data can be stored in a database, such as, RDBMS, SQL, NoSQL, etc., or as one or more files on any storage medium, such as, HDD, diskette, CD, DVD, Blu-ray Disc, EEPROM, etc. It is noted that the embodiments described in this disclosure are not limited to a specific kind of service, a specific implementation of the service, or a specific kind of content.

The system 100 comprises a machine promoter (recommender) 106 configured to generate initial recommendation results from the content data 103. The machine promoter 106 can utilize any existing or future recommendation technologies including, but not limited to, content based recommendations, collaborative filtering (CF) recommendations, and hybrid approaches. For example, Bayesian inference recommendation is described by Xiwang Yang et al. in US patent application 2013/0041862A1 published on Feb. 14, 2013; recommendation based on social network communities is described by Arpit Mathur in US patent application 2010/0287033 A1 published on Nov. 11, 2010; and recommendation based on social behavior analysis and vocabulary taxonomies is described by Sihem Amer-Yahia et al. in US patent application 2009/0164897 A1 published on Jun. 25, 2009. In addition, the machine promoter 106 may also use the rolling count algorithm implemented in Twitter.

With the user devices 1011-101n, the users can read, view, or listen to, the content provided to them. They can also give feedback, for example, like or dislike an item (or rating an item). Further, a user can promote an item that he finds of high quality if he wishes to make it more relevant for others to see.

In the embodiment, each user is associated with a user score. Information about the users and their respective user scores is saved in the user data 104. Similar to the content data 103, the user data 104 can be stored in a database, such as, RDBMS, SQL, NoSQL, etc., or as one or more files on any storage medium, such as, HDD, diskette, CD, DVD, Blu-ray Disc, EEPROM, etc.

A final promoter 105 uses the information in the user data 104 to adjust and update recommendation results dynamically. The final promoter 105 has a promotion aggregator 1051 that, after receiving promotion of an item from a user, adjusts the recommending score of that item based on the user score of the promoting user. Specifically, a user with a higher user score, who promotes an item, will have larger influence on the adjustment of that item's recommending score. In this embodiment, a promotion aggregator 1051 is configured to calculate the recommending score of an item based on the weight sum of its promotions with each promoter's user score as the weight. It is noted that other aggregate algorithms can also be used by the promotion aggregator 1051. For example, the promotion aggregator 105 can also take into consideration the old recommending score of the item, the roles of the promoter (e.g. reader, reviewer and editor, as will be described below) or any other factors that are relevant to improving recommendation quality.

The final promoter 105 further comprises a feedback analytics 1052 that adjusts the user score of the promoting user based on feedback from other users. Specifically, the feedback analytics 1052 increases the user score of a user who promotes an item if the promoted item receives positive feedback, and decreases the user score of the promoting user if the promoted item receives negative feedback. As will be described below in detail, the feedback analytics 1052 can work in parallel with the promotion aggregator. In other words, the adjustment of user scores can be performed in parallel with the update of recommending score. In an embodiment, the update of recommending score is performed immediately in real time when the system 100 receives promotion from a user; while the adjustment of user scores is performed periodically.

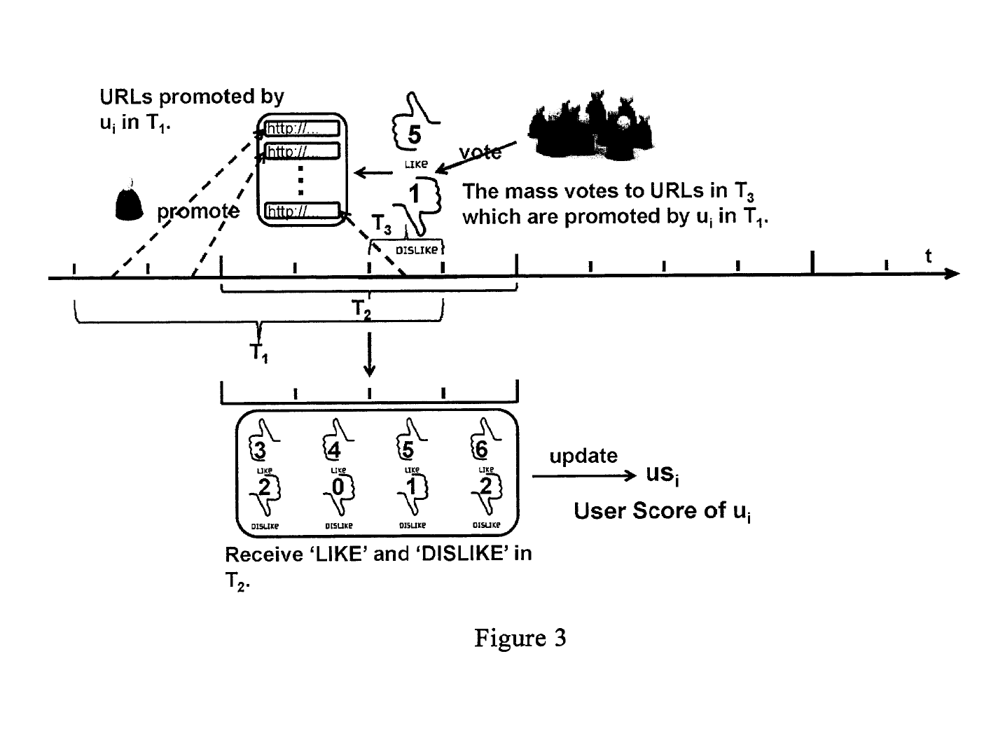

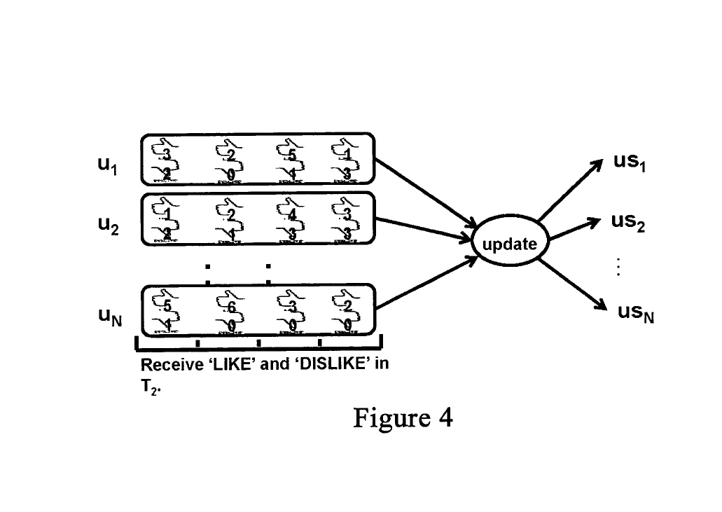

FIG. 3 shows an example of item promotion, user feedback and user score update according to an embodiment; while FIG. 4 illustrates the update of user scores. In this example, the items promoted by a user uᵢ (depicted as URLs in FIG. 3) are determined at a time interval T₁. The system updates the user score of the user uᵢ at a time interval T₂, based on the number of “Likes” and “Dislikes” the items (promoted by the user uᵢ over the last T₁) have received from other users in the last T₂.

According an embodiment, when the system starts, every user is treated equally, for example, with the same user score “1”; so the sum of all user scores is N if there are N users. When the number of users is unchanged, the total user score should remain the same after user score update. When the number of users increases, the total user score will also increase. For example, a new user is assigned a user score of “1” and the total user score will be N+1. Conversely, when the number of users decreases, the total user score will also decrease. For example, if there are n users quitting the system, then the total user score will become N−n.

In an embodiment, the system 100 rewards the promoting user uᵢ whose promoted items receive ‘LIKE’, and punishes the promoting user uᵢ whose promoted items receive ‘DISLIKE’, as follows:
The punishment is ρᵢ=(λ₁·usᵢ/(1+exp(−Nᵢ))
   If ρᵢ<η, then use ρᵢ
   Else ρᵢ≧μ, use η
   where Nᵢ is the times that uᵢ's promoted items receive ‘DISLIKE’ (perhaps λ₁=0.1, η=0.1).
Let S=Σρᵢ, R=ΣRᵢ, where Rᵢ is the times that uᵢ's promoted items receive ‘LIKE’, and the reward is πᵢ=S·Rᵢ/R.
The update formula is usᵢ=usᵢ−ρᵢ+πᵢ.

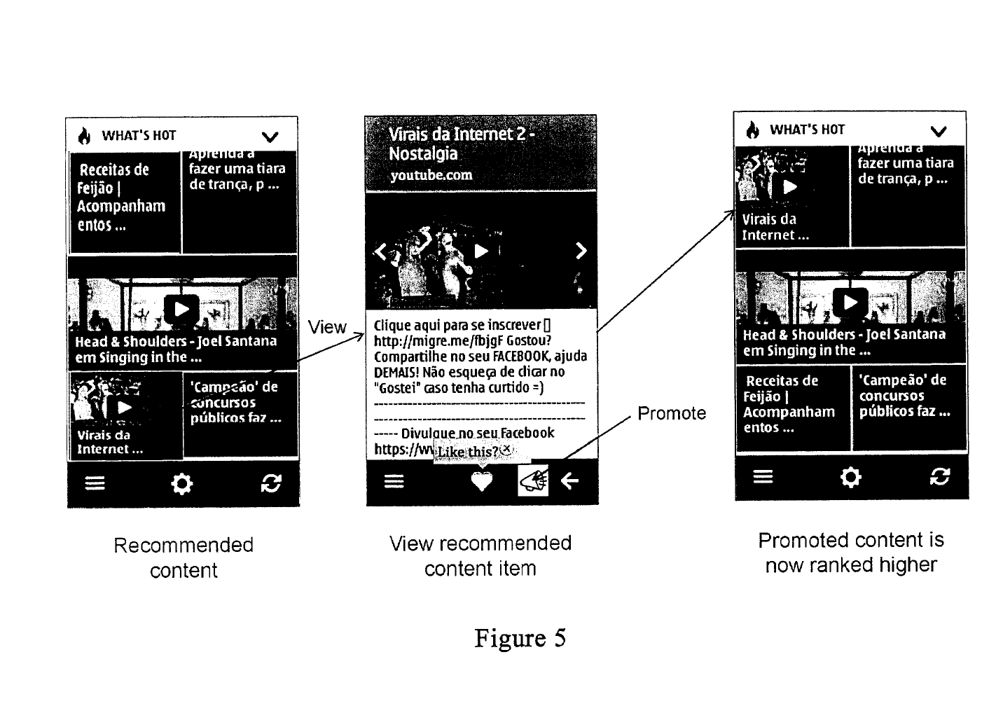

FIG. 5 shows an example of user interface with which a user can view, promote and vote items of content according to an embodiment. As shown in FIG. 5, the user is first presented with multiple recommended items according to their initial recommending scores. Then the user can choose to view one of the items by clicking that item. When viewing the item, the user may either vote (“LIKE” in this example), or promote that item. If the user promotes the item by clicking the promote button, then the recommending score of that item will be updated and the recommendation results will reflect the update.

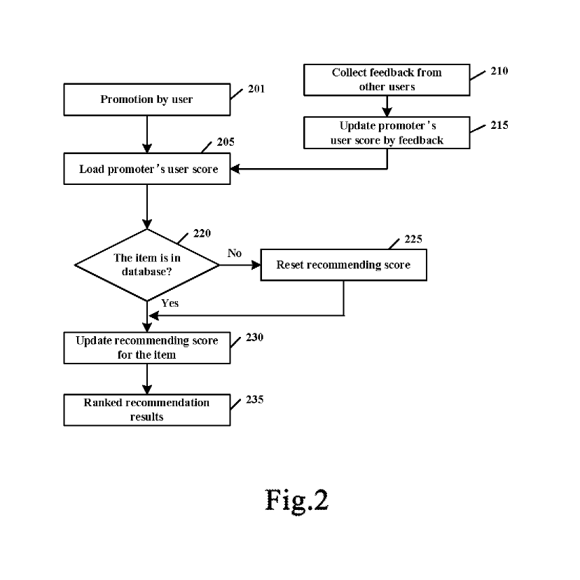

FIG. 2 depicts a process of recommendation according to an embodiment. As shown in FIG. 2, the process starts at step 201 where a user promotes an item. As explained above, when a user finds an interesting item or an item he considers of high quality, the user can promote that item. In this embodiment, the users can promote not only the items recommended by the system 100, but also items from other sources, for example, items from other service or content providers. It does not matter where an item comes from as long as its URL provides adequate information to locate its content.

In parallel with step 201, feedback from the users is collected at step 210. Similar to the above embodiments, a user can give his feedback after viewing a recommended item, in the form of, for example, like/dislike or rating. Then, the promoter's user score is adjusted according to the feedback from other users at step 215. As explained in the above embodiments, each user is associated with a user score which suggests how much weight that user's promotion carries. In other words, the user score measures how likely the items promoted by that user would become popular. In order to improve the quality of the recommended content and the activity level of the users, the system rewards a user by increasing his user score if his promoted items receive positive feedback, and punishes him by decreasing his user score if his promoted items receive negative feedback, as described above with reference to FIGS. 1, 3 and 4.

Further, as shown in the figure, steps 210 and 215 are performed in parallel with step 201. In other words, the adjustment of user scores can be performed in parallel with the update of recommending score. As illustrated in some embodiments above, the update of recommending score can be performed immediately in real time when the system receives promotion from a user; while the adjustment of user scores can be performed periodically.

After loading the promoter's user score at step 205, the process proceeds to step 220 where it is determined whether each promoted item is already in the content database. As mentioned, a user may promote an item that he finds from another source. In this case, because there is no old recommending score for that item, the system will assign an initial recommending score for the new item at step 225. Otherwise, the process proceeds to step 230 where the system updates the recommending score for each promoted item based on the user score of the promoting user, as described above with reference to FIGS. 1, 3 and 4.

After the recommending score of every promoted item has been updated, the system will update the recommendation results according to the updated recommending scores at step 235. It is noted that the process described above can be repeated to provide a continuous and real time solution for enhanced recommendation.

As shown in the above-described embodiments, a user can dynamically influence and improve the quality of the content that is recommended to other users. Depending on the other users' feedback on his promoted content (e.g. Like, Share, Dislike, Rating of the content), the user is assigned a user score that determines the level of influence he has in affecting the content recommendations. In this way, the users in the system are motivated to use the application or service and to promote the content not just to improve his own recommended content, but also to improve the content quality for the whole community. Further, users can dynamically provide feedback to the recommendation system and to the user who originally promoted the content. This allows for regulation and moderation of the content from the community. The gamification, which motivates a user to compete with others to improve the content and to get rewarded, provides a self-sustaining evolutionary system where highly active contributors (e.g. experts) and high quality content are encouraged while low quality content and lurkers are discouraged. Moreover, due to high content quality, more data are made available for improving recommendation and user profiling, therefore, the users will get a better personalized user experience.

According to an embodiment, when the system just starts and does not have any promotion from users, the process can start with machine recommendation to promote items, for example, at step 205 in FIG. 2. As described above, the machine promoter (recommender) can utilize any existing or future recommendation technologies including, but not limited to, content based recommendations, collaborative filtering (CF) recommendations, and hybrid approaches.

Further, in an embodiment, the machine recommender can be treated as a user and associated with a user score. When receiving feedback from the users, the user score of the machine recommender is also updated in a way similar to the promoting users. For example, the system can increase the machine recommender's user score if its recommended items receive positive feedback, and decrease its user score if its recommended items receive negative feedback from the users as described above with reference to FIGS. 3 and 4. In this way, the machine recommender with a high user score indicates the good recommendation performance; otherwise the machine recommender can be adaptively improved by using feedback from users as well as other users' performance. Over time, the whole system (combining two recommenders) can improve positively.

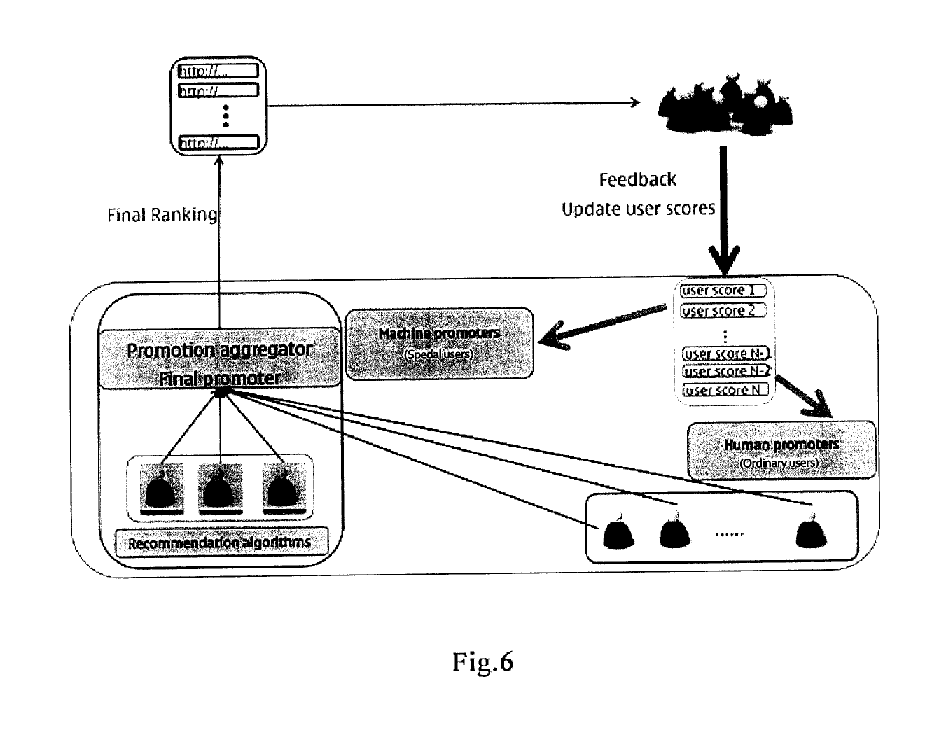

FIG. 6 shows a process of recommendation according to an embodiment. In this embodiment, there are multiple machine promoters. Similar to human promoters, each machine promoter is associated with a user score, which suggests how much influence that machine promoter will have in its promotions. The multiple machine promoters can promote (recommend) content according to different machine recommendation algorithms. As described above, any existing and future machine recommendation algorithms can be used for the machine promoters.

Among the multiple machine promoters, there is one aggregator that takes the promotion of the other promoters including both human and machine promoters as input to make the decision of what are finally recommended to the users. As explained above, the final aggregator can calculate the recommending score of an item based on the weight sum of its promotions with each promoter's user score (either human or machine promoter) as the weight. Further, the final aggregator can also take into consideration the old recommending score of the item, the roles of the promoter (e.g. reader, reviewer and editor, as will be described below) or any other factors that are relevant.

In the above embodiments, it is provided a hybrid recommendation system that combines multiple machine recommendation systems and human recommendation. Every user can play a role as human recommender when promoting an item of content. Meanwhile every user can also give feedback on the recommended items, for example, by up-vote (like) or down-vote (dislike). Where a user promotes an item, the other users' feedback (likes/dislikes) with respect to the item will be used to adjust the promoter's user score. If a user's promoted items receive overall positive feedback, the system will increase his user score, vice versa.

When no human user or very few users actively promote or vote, for example, at an early stage of the system, the machine promoters can effectively solve the cold start problem. After the users are actively involving in either promotion or voting, the system will become a hybrid recommendation system. Where the human promoters receive better feedback than the machine promoters, the system is more leaning to human recommendation. In this way, the system can benefit from both machine recommendations, for example, for solving cold start, and human recommendations, for example, to have refined performance. Moreover, the final aggregator can also be associated with a user score, which is a good indicator for measuring the effectiveness of the aggregate algorithm and the overall performance of the system.

According to another embodiment, a user can be assigned a role according to his user score. A role having more privileges requires a higher user score. For example, there can be four different roles: reader, reviewer, and editor, akin to that for the publishing process of a book or journal in the academic publishing community. This allows the user to have different permissions for acting and interacting with the content. These roles are described as follows:

Reader
α_{reader}≦user_score<α_{reviewer} where α_{reader} is the minimum user score for a user to be qualified as a reader and α_{reviewer} is the minimum user score for a user to be qualified as a reviewer
a reader can read, like, dislike, share, flag, and promote content items; and
a reader cannot provide detailed content review feedback (no feedback form is provided)

Reviewer
α_{reviewer}≦user_score<α_{editor} where α_{reviewer} is the minimum user score for a user to be qualified as a reviewer and α_{editor} is the minimum user score for a user to be qualified as an editor;
a reviewer has all privileges that a reader has (as above) plus;
a reviewer can review content through a reviewer form comprising:
   rating the quality of the content (scale of 1 to 5 with 1 being low and 5 being very high),
   rating the relevance of the content (scale of 1 to 5 with 1 being low and 5 being extremely relevant),
   recommending the content to others (yes or no), and
   commenting; and
a completed reviewer form will be sent to an editor who decides whether to accept or reject it (whether the content should be recommended or not to others);

Editor
user_score≧α_{editor} where α_{editor} is the minimum user score for a user to be qualified as an editor;
an editor has all privileges that a reviewer has (as above) plus;
an editor can add tags to content plus;
an editor can review a reviewer's feedback form and decide whether to accept or reject the content by:
   first receiving 4 completed reviews;
   if acceptance rate ≧γ then stop, where γ is the target acceptance rate, for example, 70% of all the completed reviews must have a recommendation of “yes” in order for this content to be accepted. Otherwise it is rejected;
   if acceptance rate >γ where γ>0.5, then the item is still in the content database for the recommendation system;
   if acceptance rate <γ, then remove the item from the content database.

In this embodiment, the users are assigned with different roles according to their user scores which are competitively updated based on others' feedback. A role with more privileges requires a higher minimum user score. Thus, the users are more self-motivated. It is also ensured that the users having more privileges have proved to be more trustworthy and active in reviewing and recommending content. This will subsequently ensure the overall performance of the system and the quality of recommendations.

Futher, according to an embodiment, the final aggregator can also take into consideration the roles of the promoters in deciding the recommending scores. Where the promoter is a reviewer or an editor, this will influence the recommendation results. For example, if the majority of reviewers or editors accept an item as good, then it will be given a higher recommending score and, as a result, that item will be ranked higher in the recommendation list.

According to an aspect of the disclosure it is provided an apparatus for recommending content to a plurality of user, comprising means configured to carry out the methods described above. In an embodiment, the apparatus comprises means configured to determine a recommending score for an item of content at least partly based on a user's promotion of the item and the user score of the promoting user; means configured to recommend the item according to its recommending score; and means configured to adjust the user score of the promoting user based on other users' feedback with respect to the item promoted by said user.

The apparatus can further comprise means configured to generate an initial score for the item by machine recommendation; and means configured to, after receiving promotion of the item from the promoting user, determine an updated recommending score for the promoted item at least partly based on the initial score, the promotion and the user score of the promoting user.

According an embodiment, the machine recommendation is associated with a user score, and the machine recommendation is treated as a promoting user in determining the recommending score. The apparatus further comprises means configured to adjust the user score of the machine recommendation based on feedback from the users with respect to the items recommended by the machine recommendation.

In another embodiment, the feedback from the users includes positive and negative responses, and the apparatus further comprises means configured to increase the user score of the promoting user if the promoted item receives positive feedback from the other users, and decrease the user score of the promoting user if the promoted item receives negative feedback from the other users.

According to an embodiment, before receiving any feedback from the users, each user is assigned an equal initial user score; and after the step of adjusting, the sum of all user scores remains the same.

The apparatus can further comprise means configured to assign each user a role according to its user score. A role having more privileges requires a higher user score. In an embodiment, the role is one selected from reader, reviewer and editor.

It is noted that any of the components of the system 100 depicted in FIG. 1 can be implemented as hardware or software modules. In the case of software modules, they can be embodied on a tangible computer-readable recordable storage medium. All of the software modules (or any subset thereof) can be on the same medium, or each can be on a different medium, for example. The software modules can run, for example, on a hardware processor. The method steps can then be carried out using the distinct software modules, as described above, executing on a hardware processor.

Additionally, an aspect of the disclosure can make use of software running on a general purpose computer or workstation. Such an implementation might employ, for example, a processor, a memory, and an input/output interface formed, for example, by a display and a keyboard. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. The processor, memory, and input/output interface such as display and keyboard can be interconnected, for example, via bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with media.

Accordingly, computer software including instructions or code for performing the methodologies of the disclosure, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

As noted, aspects of the disclosure may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the disclosure may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

The flowchart and block diagrams in the figures illustrate the architecture, functionality, and operation of possible implementations of systems, methods and computer program products according to various embodiments of the disclosure. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In any case, it should be understood that the components illustrated in this disclosure may be implemented in various forms of hardware, software, or combinations thereof, for example, application specific integrated circuit(s) (ASICS), functional circuitry, an appropriately programmed general purpose digital computer with associated memory, and the like. Given the teachings of the disclosure provided herein, one of ordinary skill in the related art will be able to contemplate other implementations of the components of the disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1-17. (canceled)

18. A method for recommending content to a plurality of users, wherein each user is associated with a user score, the method comprising:
determining a recommending score for an item of content at least partly based on a user's promotion of the item and the user score of the promoting user;
recommending the item according to its recommending score; and
adjusting the user score of the promoting user based on other users' feedback with respect to the item promoted by said user.

19. The method according to claim 18, wherein said step of determining further comprises:
generating an initial score for the item by machine recommendation; and
after receiving promotion of the item from the promoting user, determining an updated recommending score for the promoted item at least partly based on the initial score, the promotion and the user score of the promoting user.

20. The method according to claim 19, wherein the machine recommendation is associated with a user score, and the machine recommendation is treated as a promoting user in determining the recommending score; and said step of adjusting further comprises:
adjusting the user score of the machine recommendation based on feedback from the users with respect to the items recommended by the machine recommendation.

21. The method according to claim 18, wherein the feedback from the users comprises positive and negative responses, and said step of adjusting further comprises:
increasing the user score of the promoting user if the promoted item receives positive feedback from the other users; and
decreasing the user score of the promoting user if the promoted item receives negative feedback from the other users.

22. The method according to claim 21, wherein before receiving any feedback from the users, each user is assigned an equal initial user score; and after the step of adjusting, the sum of all user scores remains the same.

23. The method according to claim 18, further comprising:
assigning each user a role according to its user score, wherein a role having more privileges requires a higher user score.

24. The method according to claim 23, wherein the role is one selected from reader, reviewer and editor.

25. A non-transitory computer readable medium having encoded thereon statements and instructions to cause a processor to execute a method according to claim 18.

26. A system for recommending content to a plurality of users comprising:
a content database configured to store a plurality of items of content;
a user database configured to store information about the users, wherein each user is associated with a user score;
a first recommender configured to determine a recommending score for an item at least partly based on a user's promotion of the item and the user score of the promoting user, and recommend the item according to its recommending score; and
a feedback analytics configured to collect feedback from the users and adjust the user score of the promoting user based on other users' feedback with respect to the item promoted by that user.

27. The system according to claim 26, further comprising:
a second recommender configured to generate an initial score for the item through machine recommendation; and
the first recommender is configured to determine an updated recommending score for the item at least partly based on the initial score, the user's promotion of the item and the user score of the promoting user.

28. The system according to claim 27, wherein the second recommender is associated with a user score, and the first recommender is configured to treat the second recommender as a user in determining the recommending score; and
the feedback analytics is further configured to adjust the user score of the second recommender based on feedback from the users with respect to the item recommended by the second recommender.

29. The system according to claim 26, wherein the feedback from the users comprises positive and negative responses; and
the feedback analytics is configured to increase the user score of the promoting user if the promoted item receives positive feedback from the other users, and decrease the user score of the promoting user if the promoted item receives negative feedback from the other users.

30. The system according to claim 29, wherein before receiving any feedback from the users, each user is assigned an equal initial user score; and the feedback analytics is configured to keep the sum of all user scores unchanged after adjusting the user scores.

31. The system according to claim 26, wherein each user is assigned a role according to its user score and a role having more privileges requires a higher user score.

32. The system according to claim 31, wherein the role is one selected from reader, reviewer and editor.
